(19) United States
(12) Patent Application Publication
(10) Pub. No.: US 2024/0240761 A1
(43) Pub. Date: Jul. 18, 2024

(54) HYBRID MARINE REGASIFICATION SYSTEM

(71) Applicant: Stena Power & LNG Solutions AS, Grimstad (NO)

(72) Inventors: Per Gunnar Andersen, Stavanger (NO); Svein Borge Hellesmark, Fevik (NO)

(21) Appl. No.: 18/410,055

(22) Filed: Jan. 11, 2024

Related U.S. Application Data
(60) Provisional application No. 63/480,415, filed on Jan. 18, 2023.

(51) Int. Cl. F17C 9/02

(52) U.S. Cl. CPC F17C 9/02; F17C 2225/0123; F17C 2265/05; F17C 2270/0105

(57) ABSTRACT

A system for the marine regassification of liquified natural gas utilizing one or more submerged combustion vaporizers in conjunction with one or more water heated vaporizers, where the submerged combustion vaporizers are plumbed to be in parallel with the water heated vaporizers. The submerged combustion vaporizers are mounted on a fixed marine platform to ensure stability of the heat transfer bath utilized therein.

### PRIORITY CLAIM

This application claims the benefit of priority to U.S. Provisional Application No. 63/480,415, filed Jan. 18, 2023, the benefit of which is claimed and the disclosure of which is incorporated by reference in its entirety.

### FIELD OF THE INVENTION

The present disclosure relates to marine regasification terminals for liquefied natural gas, and in particular, to a fixed offshore marine regassification platform having both a water heated LNG vaporizer operated in conjunction with a submerged combustion vaporizer.

### BACKGROUND OF THE INVENTION

Import terminals for liquified natural gas (“LNG”) is a significant growing sector. Traditionally, LNG terminals are land based and constructed adjacent a purpose-built port and jetty designed to accommodate LNG marine transport vessels. An LNG terminal disposed to receive (import) LNG typically includes LNG storage tanks, a regassification facility and a bridge (pipeline) to a natural gas pipeline network.

More recently, floating storage and regasification units (FSRU) have been developed, whereby a floating marine vessel is constructed with large on-board LNG storage tanks and an on-board regassification facility. The on-board LNG storage tanks receive LNG from an LNG marine transport vessel moored adjacent the FSRU, and the on-board regassification facility regasifies LNG into gaseous natural gas and introduces the gaseous natural gas into a natural gas pipeline for distribution. One benefit to such floating storage and regassification vessels is that they can be positioned at a costal location much more readily and cost effectively than a land-based terminal.

Regardless of the location, the regassification operations require large amounts of energy in order to heat the LNG from its liquid storage temperature of −260 deg F. (−163 deg C.) to a gaseous temperature of 40 deg F. (5 deg C.). Typical heat mass required for an FSRU with large regas capacity may be 150 MW or more. As part of the regassification process, many FSRUs employ seawater to provide heat in a traditional LNG vaporizer, taking advantage of the temperature difference between the seawater and LNG at −260 degrees to warm the LNG to a point where the natural gas is converted from liquid to gas form. This method is particularly desirable because the temperature difference is considered free energy since the temperature of the water is being harnessed for the gasification process as opposed to producing heat from hydrocarbons. In such case, it is common to have a seawater intake at one side of the FSRU (such as the bow) and a seawater discharge at an opposite side of the FSRU to ensure that the colder discharge seawater does not interfere with the warmer intake seawater. In an event, such traditional LNG vaporizers may include shell and tube heat exchangers, wherein seawater is passed through a shell, such as a large pressure vessel, with a bundle of tubes disposed within the shell. LNG is directed through the tubes. As the LNG passes through the tubes, heat from the warmer seawater is transferred to the cooler LNG as part of the regassification process.

Using seawater to vaporize LNG may have a risk of freezing the seawater in the vaporizer. Sometimes an intermediate fluid, such as propane or a glycol/water mixture may be used, creating a closed loop where the intermediate fluid is heated by seawater in a heat exchanger and the warm intermediate fluid vaporizes the LNG in a vaporizer.

One common limitation to the use of seawater for regassification by FSRUs is that in order to minimize the effects on marine life of the difference (ΔT) between intake and discharge temperatures, ΔT is limited to no more than 13 deg F. (7 deg C.) by industry standards.

One drawback to regassification systems that use seawater in either configuration described above, is that the efficiency of the regassification system is reduced in locations where seawater is colder. The process is most effective and can be used year-round in locations where the temperature of the seawater is sufficiently warm that it can function as a medium to transfer heat to the LNG via the free energy. In locations where the seawater is only warm during certain periods of the year, such as the summer months, or where seawater is cold throughout the year, the free energy may need to be supplemented with additional heating sources, the most common of which is steam for an FSRU. In such case, FSRUs include large industrial, onboard steam generators to heat the seawater or the intermediate fluid used in the regassification process. Specifically, hydrocarbon fuel, such as natural gas, may be burned in a steam generator and the hot steam is used to heat a seawater-glycol loop which in turn heats the LNG.

A drawback to regassification systems that employ steam generators is that in order to achieve moderate thermal efficiency, a large amount of fuel is consumed. Moreover, such a process has high carbon dioxide emissions due to the low efficiency of fossil fueled steam boilers. In addition, due to limited steam capacity, it has been found that the FSRUs' capacity for regassification is reduced in winter months or colder environments. Finally, steam generators tend to have a large footprint, particularly to generate the amount of heat which may be required for the above-described process. Because of the limited amount of space available on an FSRU, it may not be possible to provide steam generators of the size (as measured in output heat capacity), needed to maintain regassification output at the volume capabilities available by seawater during warmer climates.

Given the growing demand for LNG regas terminals in geographic locations with cold seawater, such as Europe, and in light of ongoing efforts to reduce harmful emissions, there is a need for more efficient, more environmentally friendly solutions to LNG regassification terminals.

### BRIEF DESCRIPTION OF THE DRAWINGS

For a more complete understanding of the present disclosure and its features and advantages, reference is now made to the following description, taken in conjunction with the accompanying drawings, in which:

FIGS. 1 and 2 illustrate a marine regassification system utilizing a submerged combustion vaporizer (SCV) module in parallel with a water heated vaporizers (WHV)) module mounted on a marine platform.

FIG. 3a illustrates one embodiment of an SCV module used in the system of FIGS. 1 and 2.

FIG. 3b illustrates one embodiment of an WHV module used in the system of FIGS. 1 and 2.

FIG. 4 is a plan view of the marine platform of FIGS. 1 and 2.

FIG. 5 is a schematic of a marine regassification system having an SCV module in parallel with an WHV module with one embodiment of a heat exchange interface for the WHV module.

FIGS. 6a and 6b are schematics of a marine regassification system having an SCV module in parallel with an WHV module with other embodiments of a heat exchange interface for the WHV module.

FIG. 7 illustrates a method for offshore regassification of liquified gas utilizing a combination of SCV modules in parallel with WHV modules.

### DETAILED DESCRIPTION

Disclosed herein is a method and system for marine regassification of liquified natural gas (LNG). In particular, one or more submerged combustion vaporizers (SCV) used in regassification are mounted on a fixed marine platform, along with one or more water heated vaporizers (WHV). In one or more embodiments, the submerged combustion vaporizers are plumbed in parallel with the water heated vaporizers allowing the two different types of vaporizers to be operated in parallel.

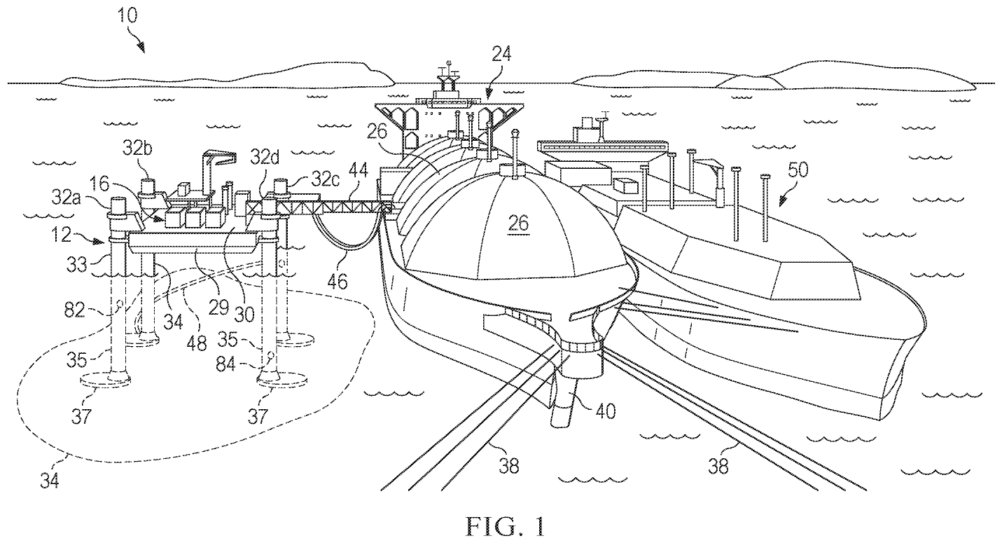

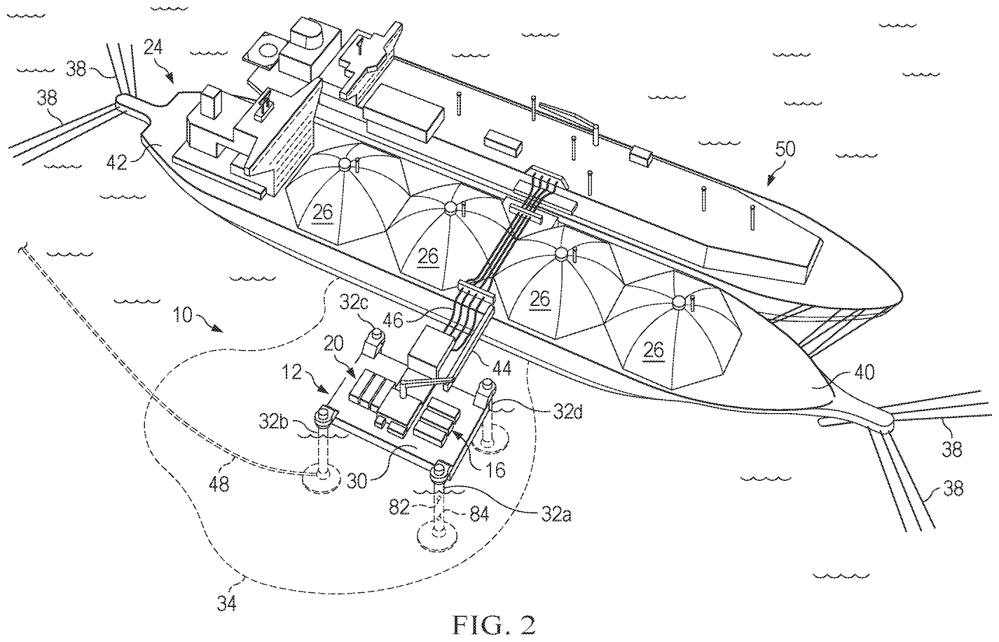

With reference to FIGS. 1 and 2, a marine regassification system 10 is illustrated and includes a fixed marine platform 12 on which is mounted one or more submerged combustion vaporizer (SCV) modules 16. In addition, marine regassification system 10 also includes one or more water heated vaporizer (WHV) modules 20 disposed fluidically in parallel with the SCV module 16. In some embodiments, the WHV module 20 may also be mounted on the fixed marine platform 12, while in other embodiments, the WHV module 20 may be mounted on a floating marine platform 24 moored adjacent the fixed marine platform 12. Likewise, marine regassification system 10 includes LNG storage tanks 26 on or adjacent to marine platform 10. In some embodiments, LNG storage tanks 26 may be carried on the floating marine platform 24. In one or more embodiments, the floating marine platform 24 is a ship moored adjacent the fixed marine flatform 12. As used herein, unless otherwise specified in a specific embodiment, an WHV module 20 is defined to mean any heat exchanger that utilizes seawater as a heat source for regassification. In one or more embodiments, the WHV is an open rack vaporizer (ORV). In addition, as used herein, where modules are described as being in parallel, the modules may be operated for regassification simultaneously or in the alternative.

As used herein, a fixed marine platform 12 is any structure that has a deck 30 supported on one or more leg, piers or supports 32 that are anchored to or otherwise affixed to the seabed 34 so as not to be subject to movement from waves, wind or other natural forces. Moreover, the marine platform 12 may be nearshore or offshore so long as seawater it utilized for vaporization as described herein. In any event, each leg 32 may have an upper end 33 adjacent the deck 30 and a lower end 35. Each leg 32 may also include a seabed engagement mechanism 37 adjacent the lower end 35. Seabed engagement mechanism may be a foot, pier or any other device for engaging seabed 34. Such fixed marine platform 12 includes, but is not limited to, conventional fixed platforms and compliant towers. Likewise, such fixed marine platform 12 may be a jack-up platform with a buoyant hull 29 supporting the deck 30.

FIGS. 1 and 2 depict a marine regassification system 10 having a fixed marine platform 12. As shown, fixed marine platform 12 is anchored directly to seabed 34. Fixed marine platform 12 includes four legs 32a, 32b, 32c and 32d extending down from deck 30 and secured to the seabed 34. In some embodiments, a storage unit 24 may be positioned adjacent fixed marine platform 12. Storage unit 24 includes storage tanks 26. Where a storage unit 24 is present, storage unit 24 may be a fixed storage unit or a floating storage unit. A fixed storage unit would include a fixed marine platform, such as fixed marine platform 12, on which storage tanks 26 are positioned. FIGS. 1 and 2 illustrated storage unit 24 as a floating storage unit 24 moored adjacent fixed marine platform 12. In one or more embodiments, floating storage unit 24 is a marine vessel that is disposed to be moored for long term deployment adjacent fixed marine platform 12. In this regard, floating storage unit 24 may include a spread mooring system 38 at one or both of the bow 40 and stern 42 of floating storage unit 24 that allows floating storage unit 24 to be moored in close proximity to fixed marine platform 12. This close proximity in turn permits a bridge 44 to be installed between the floating storage unit 24 and fixed marine platform 12. Also shown are one or more LNG transfer hoses 46 extending from floating storage unit 24 and fixed marine platform 12 to transfer LNG from the storage tanks 26 to fixed marine platform 12 for regassification. LNG transfer hoses 46 may be cryogenic hoses suspended above the water surface.

In the illustrated embodiment, both the WHV module 20 and the SCV module 16 are mounted on deck 30. While SCV module 16 is always mounted on a fixed platform such as fixed marine platform 12, in one or more embodiments, WHV module 20 may be mounted on a separate floating platform, such as floating storage unit 24. WHV module 20 may also be mounted on a separate fixed marine platform (not shown) that is adjacent fixed marine platform 12.

In some embodiments, to enable distribution of the natural gas, a high-pressure gas conduit 48 may extends from the fixed marine platform 12 to a remote location, such as an onshore natural gas distribution terminal (not shown). In other embodiments, the natural gas may be used locally, such as by a power production system (not shown) utilized to generate electricity.

Moored adjacent floating storage unit 24 is a traditional LNG marine transport vessel 50 utilized in some embodiments, to deliver LNG to the floating marine platform. In some embodiments, the total volume of the storage tanks 26 on floating storage unit 24 is significantly greater than the total volume of LNG transportable from any given marine transport vessel 50, thus allowing continuous or substantially continuous regasification operations as LNG transport vessels, such as LNG marine transport vessel 50, arrive at marine regassification system 10 to unload LNG cargo. For example, a typical LNG marine transport vessel 50 may have a total LNG storage capacity of 174,000 m3, whereas floating storage unit 24 may have a total LNG storage capacity of 212,000 m3. Moreover, while marine regassification system 10 is illustrated as having a storage unit 24 at fixed marine platform 12, in other embodiments, storage unit 24 may be eliminated and marine transport vessel 50 may be moored adjacent fixed marine platform 12 so that LNG can be transferred directly from LNG marine transport vessel 50 to fixed marine platform 12 for regassification without temporary storage of the LNG by storage unit 24. In still other embodiments, LNG may be delivered to fixed marine platform via pipeline (not shown) and stored in storage unit 24.

In some embodiments, at least one leg 32 includes a seawater intake 82 through which seawater may be pumped for use in the gasification process. Likewise, in some embodiments, at least one leg 32 includes a seawater discharge 84 through which seawater utilized in the gasification process may be discharged. It will be appreciated that the seawater intake(s) 82 may be spaced apart from the seawater discharge 84 to ensure that the cooler water being released by the seawater discharge 84 does not impact the free energy of the seawater drawn in by the seawater intake(s) 82. Moreover, to maximize the free energy available from the seawater for use in the gasification process as described herein, in some embodiments, the seawater intakes 82 may be positioned closer to the upper end 33 of a leg 32, where seawater is likely to be warmer. Likewise, to minimize the temperature difference (ΔT) between the discharge water and the seawater to which it is returned, as well as the impact of discharged water on the local environment, the seawater discharge 84 may be positioned closer (relative to intake 82) to the lower end 35 of leg 32 where seawater is likely to be colder. While some embodiments of intake and discharge arrangements have been described, the disclosure is not limited to any particular arrangement. For example, one or both of the intake and discharge may be in separate legs 32. In some embodiments where large amounts of water are required, each leg 32, or at least multiple legs 32, may include a seawater intake 82 with a seawater discharge 84 located in a separate conduit(s) (not shown) extending away from fixed marine platform 12. Additionally, while seawater intake 82 and seawater discharge 84 are generally shown in legs 32, in other embodiments, one or both may be located in conduits (not shown) separate from legs 32.

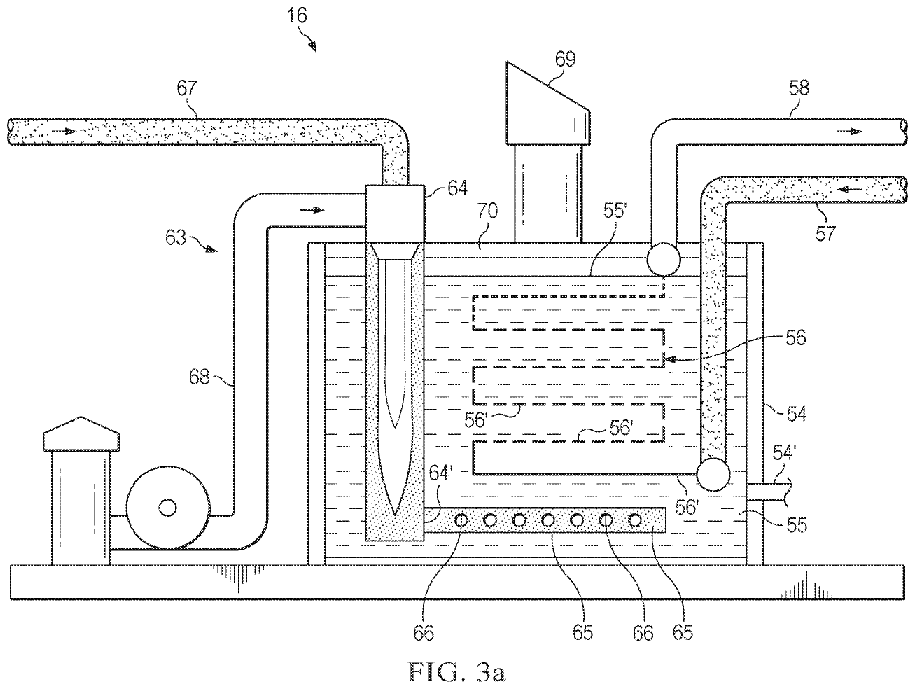

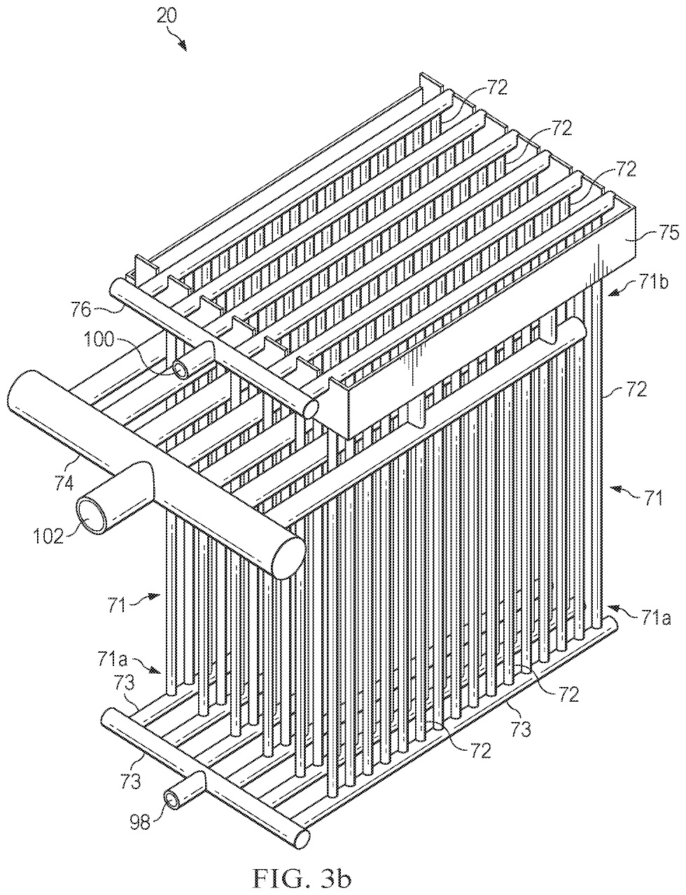

Turning to FIG. 3a, although SCV module 16 is not limited to a particular configuration, in one or more embodiments, SCV module 16 includes a tank or container 54 filled with a heat transfer bath 55, such as water, characterized by a bath surface 55′. In some embodiments, container 54 may be elongated and horizontal so that bath surface 55′ has a large open surface area. In some embodiments, tank 54 may include a port 54′ for supplying bath 55 to tank 54. Disposed within bath 55 is a heat exchanger 56 that is in fluid communication with an LNG inlet 57 and a natural gas outlet 58. In one or more embodiments, heat exchanger 56 is a tube bank which may be comprised of a plurality of tubes. Heat exchanger 56 is at least partially submerged in bath 55. A heat source 63 is provided to deliver heat to heat transfer bath 55. In one or more embodiments, heat source 63 may an industrial plant (not shown) where warm water or other fluid resulting from the source may be circulated into tank 54 via port 54′. In one or more other embodiments, heat source 63 is a combustion system disposed in or adjacent to tank 54. In embodiments where heat source 63 is a combustion system, heat source 63 may include a combustion chamber or burner 64 having one or more combustion gas outlets 64′ in fluid communication with one or more combustion gas conduits 65 disposed within bath 55, each gas conduit 65 having a plurality of apertures 66 for release of combustion gasses into heat transfer bath 55. In some embodiments, combustion gas conduits 65 may be positioned in bath 55 below heat exchanger 56 so that combustion gases released from conduit 64 via apertures 66 flow across heat exchanger 56 as the combustion gasses rise to the surface 55′ of bath 55, thereby transferring heat by convection. A fuel gas inlet 67 and a combustion air inlet 68 deliver fuel gas and air, respectively, to combustion chamber 64. The arrangement and orientation of combustion chamber 64 is not intended as a limitation, however, in some embodiments, combustion chamber 64 may be positioned within the bath 55 to ensure that as much heat as possible from the combustion of the fuel is transferred to bath 55, through both conduction and convention. However, in other embodiments, combustion chamber 64 may be external to bath 55 and/or container 54 so long as combustion gasses are delivered to bath 55. Finally, SCV module 16 may include an exhaust stack 69 for releasing exhaust gas bubbling to the surface 55′ of bath 55. As used herein, SCV module 16 is any non-pressurized system utilizing a heat transfer structure, such as tube banks or plates, that are submerged in a bath which bath is heated by flue gases. Although combustion chamber 64 is illustrated as disposed in bath 55 for delivery of flue gasses, in other embodiments, the flue gasses may arise from other sources, such as industrial processes (not shown). Moreover, while heat source 63 is described as having a combustion system, in other embodiments, heat source 63 may be electric or another source of heat.

In some embodiments, tank 54 may include a cover 70. In some embodiments, cover 70 may facilitate collection of flue gases rising through bath 55 to surface 55′ for removal via exhaust stack 69. While tank 54 may include a cover 70, it will be appreciated SCV module 16 is not intended to be a pressurized system, and as such tank 54 is not a pressure vessel, but rather may be open to the atmosphere via exhaust stack 69. As such, neither tank 54 nor bath 55 are pressurized. In order to ensure that bath 55 is not subject to sloshing induced by external environmental forces, such as waves, ocean currents or wind, SCV module(s) 16 must be mounted on a marine platform 12 that is secured or fixed to the seabed 34 (see FIG. 2). While sloshing of bath 55 could damage container 54 as well as other components of SCV module 16, it will be appreciated that such sloshing could also impact the effectiveness of heat transfer from the combustion gas to the to the natural gas passing through heat exchanger 56. Being fixed as described herein, the dynamic effects of external environmental forces on SCV module 16 are minimized, ensure stability of the heat transfer bath 55 utilized therein.

When secured in a manner that prevents external environmental forces from causing bath 55 to slosh, SCV module 16 can provide high thermal efficiency to marine regassification system 10. First, SCV module 16 has a comparatively low exhaust temperature. Since fuel gas combustion is performed submerged in a water bath, the exhaust temperature may be as low as 60-70 deg F. (15-20 deg C.). Low exhaust temperature results in high thermal efficiency. In contrast, the exhaust temperature for prior art steam-based systems may be 400 deg F. or more. Second, SCV module 16 results in condensation of combustion air. Part of the vapor in the combustion air is condensed in bath 55 during the fuel gas burning/combustion process. Condensation of water vapor, in turn, releases significant amount of free energy (opposite the function of a cooling tower). As a result of the above factors, the thermal efficiency of SCV 16 may be 98% or higher.

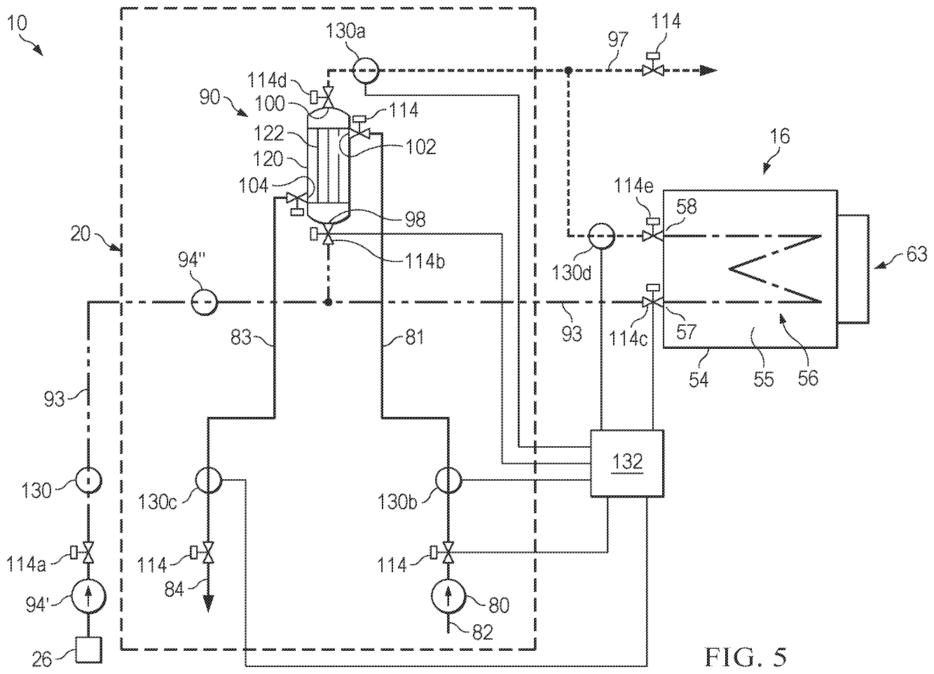

With reference to FIG. 3b, although WHV module 20 is not limited to a particular configuration, in one or more embodiments, WHV module 20 includes vertical heat exchange tube banks 71, each vertical tube bank 71 formed of a plurality of elongated tubes 72. An LNG delivery manifold 73 having an LNG inlet 98 is disposed at a lower end 71a of each tube bank 71 and in fluid communication with the elongated tubes 72 of the tube bank 71. A natural gas collection manifold 76 having a natural gas outlet 100 is disposed at an upper end 71b of each tube bank 71 and in fluid communication with the elongated tubes 72 of the tube bank 71. Likewise, a working fluid distribution manifold 74 having a working fluid inlet 102 is disposed at an upper end 71b of the tube banks 71. In one or more embodiments, working fluid distribution manifold 74 may deliver a working fluid to a working fluid distribution system 75 positioned adjacent the upper end 71b of tube banks 71 and disposed to release a working fluid, such as seawater, so as to flow down tube banks 71 along an outer surface of elongated tubes 72, causing LNG within the elongated tubes 72 to vaporize. In some embodiments, working fluid distribution system 75 may be a reservoir positioned adjacent upper end 71b of the tube banks 71. In some embodiments, working fluid distribution system 75 may be one or more tubulars positioned adjacent upper end 71b of the tube banks 71. In one or more embodiments, elongated tubes 72 may be vertically arranged in tube banks 71. In one or more embodiments, elongated tubes 72 may be horizontally arranged in tube banks 71. Working fluid distribution system 75 may be pipes, containers or other containment structures that can receive and release a working fluid over elongated tubes 72. It will be appreciated that as the working fluid travels down tube banks 71, the seawater becomes colder as heat is transferred to the natural gas flowing upward through elongated tubes 72. In this regard, it is desirable to ensure that the working fluid, particularly where it is seawater, is delivered to the working fluid distribution manifold 74 at a temperature sufficiently high that that the seawater will not freeze on tube banks 71 during the vaporization process. In other words, it is desirable that the temperature of the seawater upon completion of the vaporization process is at least 2-3 degrees Celsius. In any event, the working fluid is collected adjacent the lower end 71a of the tube banks 71 and directed to a working fluid outlet 104 (see FIG. 5). In some embodiments where the working fluid is seawater, working fluid inlet 102 is in fluid communication with seawater intake 82 (see FIG. 1).

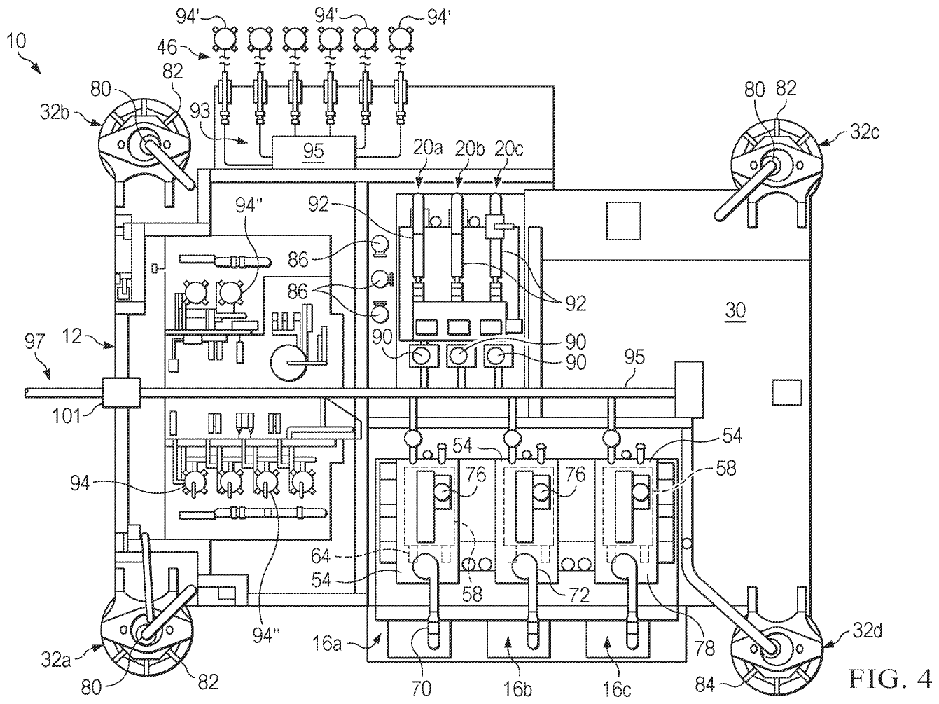

Turning to FIG. 4, a plan view of one embodiment of fixed marine platform 12 of a marine regassification system 10 is shown. Specifically, fixed marine platform 12 includes a deck 30 with legs 32a, 32b, 32c and 32d supporting deck 30, although a greater number or fewer number of legs may be utilized. In this embodiment, each of legs 32a, 32b, 32c and 32d are secured to the seabed 34.

Mounted on deck 30 are three WHV modules 20a, 20b and 20c and three SCV modules 16a, 16b, and 16c, although it will be appreciated that a larger number or smaller number of WHV modules 20 and SCV modules 16 may be utilized. Moreover, the number of WHV modules 20 and SCV modules 16 need not be equivalent, but may be selected based on the average annual seawater temperature where the fixed marine platform 12 is deployed. Where the average annual seawater temperature is higher, then there may be more opportunity to utilize free energy of the seawater for gasification, resulting in more WHV modules 20 and fewer SCV modules 16. Where free energy from seawater may be more limited, such as in northern and southern oceans, then a greater number of SCV modules 16 may be required.

One or more LNG pumps 94 are utilized to pump LNG from a storage tank 26, whether on a storage unit 24 or LNG marine transport vehicle 50 or marine platform 12 or otherwise, to WHV module(s) 20 and SCV module(s) 16 via a pipe network 93 that can deliver LNG to WHV module(s) 20 and SCV module(s) 16 in parallel. In this regard, in one or more embodiments, pipe network 93 may include a distribution manifold 95 that can allow LNG to be directed to WHV module(s) 20 and SCV module(s) 16 in parallel. LNG pumps 94 may be located on fixed marine platform 12 or on the storage unit 24 or on LNG marine transport vehicle 50. It will be appreciated that additional LNG pumps 94 may be utilized on fixed marine platform 12 to assist in distribution of the LNG to the WHV module(s) 20 and SCV module(s) 16. In one or more embodiments, low pressure LNG pumps 94′ pump LNG from storage tanks 26 (not shown), while high pressure LNG pumps 94″ pump LNG to both types of vaporizers, namely WHV module(s) 20 and SCV module(s) 16 for regasification out to the pipeline network.

In any event, a first portion of the liquified natural gas can be pumped to the one or more WHV module(s) 20 where seawater may be used to regasify the first portion of the liquified natural gas, and a second portion of the liquified natural gas can be pumped to the one or more SCV modules where the second portion of the liquefied natural gas can be regassified utilizing the SCV module(s) 20 on board the fixed marine platform 12. In one or more embodiments, the liquefied natural gas is delivered as a liquid stream and the liquid stream is divided into a first portion and a second portion. In one or more embodiments, the liquified natural gas is pumped to each of WHV module(s) 20 and SCV module(s) 16 in parallel in parallel.

In one or more embodiments, each WHV module 20 includes at least a first heat exchanger 90. In some embodiments, each WHV module 20 may also include a second heat exchanger 92. In addition, each SCV module 16 includes a tank 54, one or more combustion chambers 64, one or more combustion gas conduits 65, and a tube bank 56 which may be comprised of a plurality of tubes 56′. Although tank 54 may be open to the atmosphere, in other embodiments, SCV module 16 may also include a cover 70 and an exhaust stack 69 as shown in FIG. 3a.

Where WHV module 20 includes only a first heat exchanger 90, first heat exchanger may be an WHV heat exchanger disposed to utilize the free energy from seawater directly to gassify LNG. Where WHV module 20 includes a first heat exchanger 90 and a second heat exchanger 92, seawater may be pumped to second heat exchanger 92 where free energy from the seawater is transferred to an intermediate heat exchange fluid, which in turn is utilized in first heat exchanger 90 to gassify the LNG. For example, in the illustrated embodiment of FIG. 3b, an intermediate heat exchange fluid would be delivered via working fluid distribution manifold 74. In either case, it will be appreciated that free energy from seawater is utilized in the WHV module 20, either directly or indirectly through an intermediate working fluid, for gasification.

Although not limited to a particular type of heat exchanger, in one or more embodiments, first heat exchanger 90 may be similar to that shown in FIG. 3b, while in other embodiments, first heat exchanger 90 may be a shell and tube heat exchanger in which LNG gassified utilizing an intermediate heat exchange fluid, such as glycol or a glycol water mixture or propane, among other fluids. In other embodiments, first heat exchanger 90 may be a plate and frame heat exchanger or other type of heat exchanger.

In one or more embodiments, second heat exchanger 92 is a heat exchanger in which seawater is used as a heat transfer fluid to warm the intermediate heat exchanger fluid utilized in first heat exchanger 90. Although not limited to a particular type of heat exchanger, in one or more embodiments, second heat exchanger 92 may be a plate and frame heat exchanger, a shell and tube heat exchanger or other type of heat exchanger so long aa seawater is utilized in the heat transfer process.

It will be appreciated that an WHV module 20 having both a first heat exchanger 90 and a second heat exchanger 92 permits WHV module 20 to operate utilizing a wider temperature range of seawater, as opposed to an WHV module 20 utilizing only a first heat exchanger 90. Specifically, the second heat exchanger 92 permits use of seawater that has a temperature closer to 0° ° C. because the temperature drop will be less than if the seawater is utilized directly for heating LNG. Thus, this opens up the possibility that this arrangement can be utilized in cooler conditions than a WHV module 20 utilizing seawater directly as the heat source. WHV modules 20 utilizing only a first heat exchanger 90 are best utilized in environments where seawater is warmer and less likely to freeze in first heat exchanger 90. Where seawater is more likely to freeze during the gassificaiton of LNG, in order to avoid damage to the WHV module 20, and intermediate heat transfer fluid may be utilized as described in the double heat exchanger arrangement.

In any event, natural gas from WHV module(s) 20 and SCV module(s) 16 is collected for distribution in a pipe network 97. In this regard, in one or more embodiments, pipe network 97 may include a collection manifold 99. A knockout drum 101 may be included along pipe network 97 downstream of the WHV module(s) 20 and SCV module(s) 16 to separate any liquid that may remain in the gaseous stream produced from WHV module(s) 20 and SCV module(s) 16.

Turning to FIG. 5, a process flow diagram of marine regassification system 10 is shown. In this embodiment, marine regassification system 10 illustrates an SCV module 16 disposed in parallel with an WHV module 20 having only a first heat exchanger 90. First heat exchanger 90 includes an LNG inlet 98, a natural gas outlet 100, a working fluid inlet 102 and a working fluid outlet 104. LNG pumps 94 are in fluid communication with the LNG inlet 98 of first heat exchanger 90 via pipe network 93 as well as LNG inlet 57 of SCV module 16 via pipe network 93. In one or more embodiments, low pressure LNG pumps 94′ pump LNG from storage tanks 26, while high pressure LNG pumps 94″ pump LNG to both types of vaporizers, namely WHV module(s) 20 and SCV module(s) 16 for regasification out to the pipeline network. For example, lower pressure LNG pumps 94′ may pump at approximately 6-8 bar, while high pressure LNG pumps 94″ may pump at approximately 70-120 bar. It will be appreciated that pipe network 93 is not limited to any particular arrangement so long as LNG can be selectively pumped either to SCV module(s) 16 or to WHV module(s) 20 or simultaneously to both SCV module(s) 16 or WHV module(s) 20 so that SCV module(s) 16 and WHV module(s) 20 may be operated in parallel, where LNG is delivered to both SCV module(s) 16 and WHV module(s) 20, and natural gas is removed from SCV module(s) 16 and to WHV module(s) 20 simultaneously. To facilitate such operation, pipe network 93 may include one or more adjustable valves 114 to control liquified gas flow to one or more of the WHV module(s) 20 and one or more of the SCV module(s) 16. One or more inlets and outlets of SCV module(s) 16 and WHV module(s) 20 may include such valves 114. In the illustration, each of SCV module 16 and WHV module 20 includes an inlet valve 114b, 114c, respectively, controlling the flow of LNG into inlets 98 and 57. In the illustrated embodiment, the working fluid utilized to transfer heat to the LNG within WHV module 20 is seawater. As such, a seawater intake pump 80 is in fluid communication with the working fluid inlet 102 to deliver seawater to first heat exchanger 90 for heating LNG passing therethrough. In one or more embodiments, seawater intake pump 80 may be in fluid communication with seawater intake 82 (see FIG. 4). Likewise, working fluid outlet 104 of first heat exchanger 90 may be in fluid communication with the seawater discharge 84 (see FIG. 4). It will be appreciated that WHV module 20 is not limited to a particular type or configuration of heat exchange so long as WHV module 20 utilizes seawater as the working fluid medium (either directly or indirectly), thereby taking advantage of free energy discussed above for purposes of LNG gasification. For purposes of the disclosure, an WHV module 20 is defined as any heat exchange unit or system utilized for gasification of a liquified fluid utilizing the free energy of seawater, and is not limited to a water heated design, but may include any type of heat exchanger. Likewise, while marine regassification system 10 is described for use in regassification of LNG, regassification of any liquid is contemplated to the extent the liquid can be regassified at least in part utilizing the free energy of seawater. For example, marine regassification system 10 may be used in the regassification of liquified ammonia or other liquified gasses.

Also shown in FIG. 5 in parallel with WHV module 20 is SCV module 16. In one or more embodiments, SCV module 16 includes an atmospheric pressure tank or container 54 filled with a heat transfer bath 55, such as water. Disposed within bath 55 is a heat exchanger 56 in fluid communication with an LNG inlet 57 and a natural gas outlet 58. Heat exchanger 56 may comprise a plurality of tube 56′ (see FIG. 3a) which in some embodiments, may be substantially horizontal in container 54. A heat source 63 delivers heat to heat transfer bath 55. Thus, in some embodiments, WHV module 20 may be the system as illustrated and described with reference to FIG. 3.

In some embodiments, one or more sensors 130 may be used to measure a condition of marine regassification system 10 and adjust the relative operation of WHV module 20 and an SCV module 16 based on the measured condition. Specifically, a sensor 130a at the natural gas outlet 100 may be used to monitor a condition of natural gas passing from WHV module 20, such as for example, natural gas temperature or natural gas flowrate from first heat exchanger 90. A controller 132 monitoring this sensor 130a may then adjust the valves 114b and 114c to first heat exchanger 90 and SCV module 16, respectively. Specifically, a drop in temperature of natural gas discharged from WHV module 20 is an indication that the temperature of intake seawater utilized in first heater exchanger 90 is not sufficiently warm enough, i.e., lacks the free energy to achieve a desired natural gas output temperature at natural gas outlet 100. Thus, controller 132 may be used to operate valve 114b to limit flow of LNG into first heat exchanger 90 and operate valve 114c to increase LNG flow into SCV module 16. In one or more embodiments, as the natural gas temperature measured by sensor 130a drops over time, controller 132 may gradually adjust each of valves 114b and 114c in concert, closing valve 114b and opening valve 114c, whereby the measured drop in temperature is an indication that the seawater utilized in the gasification process is becoming cooler with less free energy available for the gasification process. In other embodiments, rather than measuring a condition of the natural gas following regassification, the temperature of the intake seawater may be measured by sensor 130b, which may be disposed along a seawater intake line 81 and used as the basis for adjustment of the valves 114b, 114c. In this case, during cooling conditions, as the measured temperature of the water decreases, LNG flow to the SCV module 16 may be increased while LNG flow to the WHV module 20 may be decreased. Alternatively, during warming conditions, as the measured temperature of the intake seawater increases, LNG flow to the WHV module 20 may be increased while LNG flow to the SCV module 16 may be decreased. In yet other embodiments, a sensor 130c disposed along a seawater return line 83 in fluid communication with seawater outlet 84 may be utilized to measure the temperature of the seawater to be returned to the ocean for comparison with the temperature of the intake seawater measured by sensor 130b. If the difference in measured temperatures is great than a predetermined amount, such as 7 degrees, then LNG flow to SCV module 16 may be increased and LNG flow to WHV module 20 may be decreased. This may be useful to ensure that return water is within a defined temperature range in order to satisfy regulatory requirements, for example. Finally, a sensor 130d may be utilized to measure a condition of natural gas exiting SVC module 16, for comparison with a condition of natural gas exiting WHV module 20 as measured by sensor 120a. The operation of one or both of WHV module 20 and SCV module 16 may be adjusted accordingly so that the measured conditions are within a predetermined range to facilitate mixing of the gas flow stream exiting WHV module 20 with the gas flow stream exiting SCV module 16. For example, in some embodiments, it is desirable to ensure that the temperature of natural gas leaving WHV module 20 is within 30 degrees of the temperature of natural gas leaving SCV module 16 in order to avoid downstream flow turbulence or interruption when the two gas streams mix. In any event, use of one of the WHV module 20 or SCV module 16 may be phased in or phased out depending on one or more of the measured conditions. In addition thereto, or alternatively, the measured condition may be utilized to adjust the flow rate of either the liquified natural gas through WHV module 20 or the working fluid through WHV module 20. In this regard, in order to fully utilize the free energy in the seawater the residency time of the seawater in the WHV module 20 may be altered by adjusting the flowrate of the seawater through the WHV module 20.

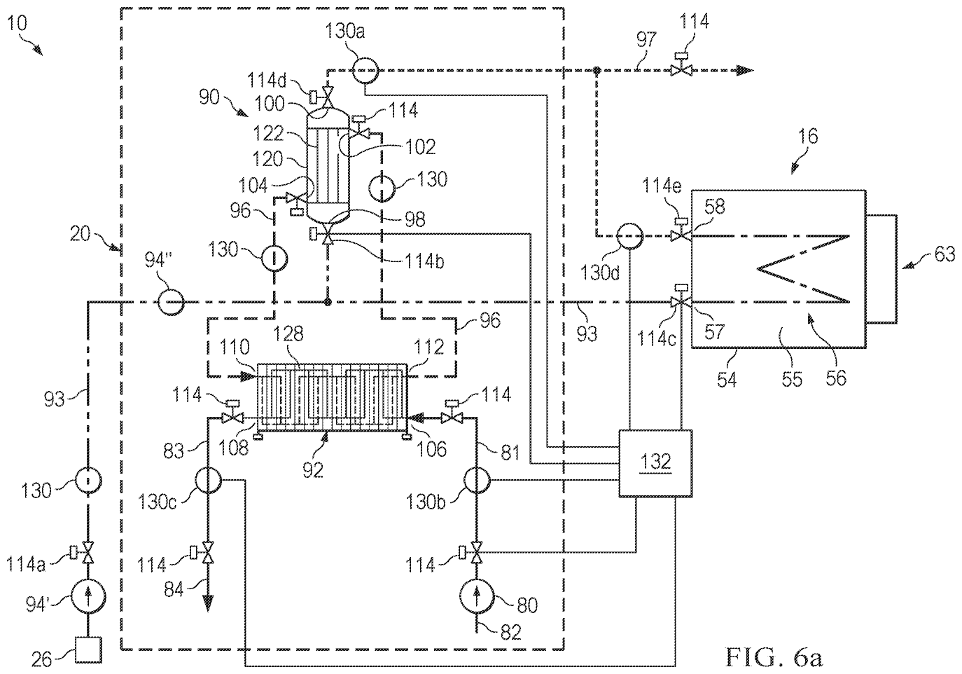

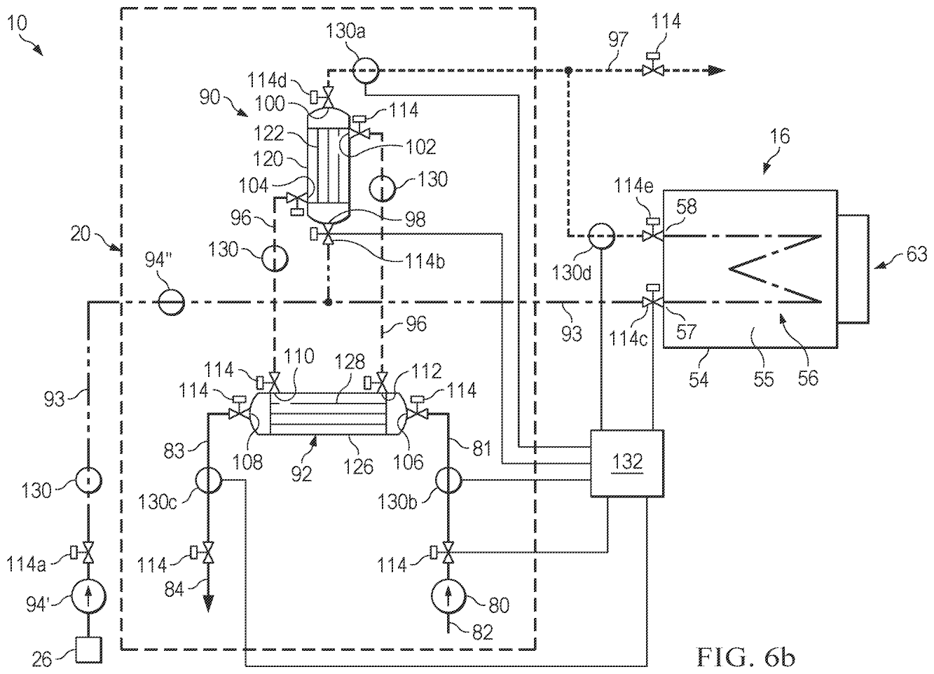

Turning to FIGS. 6a and 6b, embodiments of marine regassification system 10 are shown where WHV module 20 includes both a first heat exchanger 90 and a second heat exchanger 92. A process fluid flow loop 96 containing an intermediate fluid as the working fluid for gassification fluidically interconnects first heat exchanger 90 to second heat exchanger 92 to allow a working fluid to flow therebetween. Although the working fluid of process fluid flow loop 96 is not limited to a particular fluid, in one or more embodiments, the working fluid may be a mixture of water and glycol. In some embodiments, the working fluid may be water, while in other embodiments, the working fluid may be another heat transfer fluid, such as propane. First heat exchanger 90 includes an LNG inlet 98, a natural gas outlet 100, a working fluid inlet 102 and a working fluid outlet 104. Second heat exchanger 92 includes a seawater inlet 106, a seawater outlet 108, a working fluid inlet 110 and a working fluid outlet 112. Each inlet and outlet of each heat exchanger 90, 92 may include a valve 114 to control flow therethrough.

Although not limited to a particular type of heat exchanger, in one or more embodiments, first heat exchanger 90 may be a shell and tube heat exchanger and include a vessel 120 with a tube bundle 122 disposed therein. In such case, each of the working fluid inlet 102 and working fluid outlet 104 are disposed in the vessel 120, and the LNG inlet 98 and natural gas outlet 100 are in fluid communication with the tube bundle 122 as is known in the art. In one or more embodiments, the vessel 120 is elongated and vertical to enhance natural gas flow therefrom through natural gas outlet 100. In any event, the LNG pump 94 is in fluid communication with the LNG inlet 98 of first heat exchanger 90 via a pipe network 93.

Second heat exchanger 92 includes a working fluid inlet 110 and working fluid outlet 112 as well as a seawater inlet 106 and a seawater outlet 108. The working fluid inlet 110 is in fluid communication with the working fluid outlet 104 of first heat exchanger 90, and the working fluid outlet 112 is in fluid communication with the working fluid inlet 102 of first heat exchanger 90. Seawater pump 80 is in fluid communication with the seawater inlet 106 to deliver seawater to second heat exchanger 92 for heating the working fluid in process fluid flow loop 96. In one or more embodiments, seawater pump 80 may be in fluid communication with seawater intake 82 (see FIG. 4). Likewise, seawater outlet 108 of second heat exchanger 92 may be in fluid communication with the seawater discharge 84 (see FIG. 4).

Second heat exchanger also includes a heat exchange interface 128. In one or more embodiments as illustrated in FIG. 6a, heat exchanger interface 128 is a plurality of heat transfer plates stacked together to form a heat plate bank. In such case, each of the working fluid inlet 110 and working fluid outlet 112 are in fluid communication with a channel formed on one side of each plate, and the each of the seawater inlet 106 and seawater outlet 108 are in fluid communication with a channel formed on the other side of each plate. In one or more embodiments as illustrated in FIG. 6b, heat exchanger interface 128 is a tube bundle disposed within a vessel 126. In such case, each of the working fluid inlet 110 and working fluid outlet 112 are disposed in the vessel 126, and the seawater inlet 106 and seawater outlet 108 are in fluid communication with the tube bundle 128. Neither first heat exchanger 90 nor second heat exchanger 92 are limited to a particular heat exchange interface other than it is contemplated that seawater is utilized in the gasification process utilizing WHV module 20 in order to utilize free energy of the seawater when conditions permit.

In some embodiments, one or more sensors 130 may be used to measure a condition of marine regassification system 10 and adjust the relative operation of WHV module 20 and an SCV module 16 based on the measured condition. Specifically, a sensor 130a at the natural gas outlet 100 may be used to monitor a condition of natural gas passing from WHV module 20, such as for example, natural gas temperature or natural gas flowrate from first heat exchanger 90. A controller 132 monitoring this sensor 130a may then adjust the valves 114b and 114c to first heat exchanger 90 and SCV module 16, respectively. Specifically, a drop in temperature of natural gas discharged from WHV module 20 is an indication that the temperature of intake seawater utilized in second heater exchanger 92 is not sufficiently warm enough, i.e., lacks the free energy, to heat the working fluid of flow loop 96 to achieve a minimum natural gas output temperature at NG outlet 100. Thus, controller 132 may be used to operate valve 114b to limit flow of LNG into first heat exchanger 90 and operate valve 114c to increase LNG flow into SCV module 16. In one or more embodiments, as the natural gas temperature measured by sensor 130a drops over time, controller 132 may gradually adjust each of valves 114b and 114c in concert, closing valve 114b and opening valve 114c, whereby the measured drop in temperature is an indication that the seawater utilized in the gasification process is becoming cooler with less free energy available for the gasification process. In other embodiments, rather than measuring a condition of the natural gas following regassification, the temperature of the intake seawater may be measured by sensor 130b and used as the basis for adjustment of the valves 114b, 114c. In this case, during cooling conditions, as the measured temperature of the water decreases, LNG flow to the SCV module 16 may be increased while LNG flow to the WHV module 20 may be decreased. Alternatively, during warming conditions, as the measured temperature of the intake seawater increases, LNG flow to the WHV module 20 may be increased while LNG flow to the SCV module 16 may be decreased.

As shown, LNG pump(s) 94 are disposed to pump LNG in parallel to each of WHV module(s) 20 and SCV module(s) 16 via a pipe network 93. Based on demand and environmental conditions, it may be determined whether to operate individually only WHV module(s) 20 or only SCV module(s) 16, or alternatively to operate both WHV module(s) 20 and SCV module(s) 16 at the same time in parallel. As environmental conditions change, such as for example, a change in the temperature of the seawater, in one or more embodiments, gasification can be transitioned from primarily use of WHV module(s) 20 to primarily use of SCV module(s) 16, or vice versa. For example, as seawater transitions from an intake temperature T1 to a cooler intake temperature of T2 (such as from summer weather to winter weather), marine regassification system 10 may transition from primary use of WHV module(s) 20 to primary use of SCV module(s) 16, and may even suspend use of WHV module(s) 20 if the seawater temperature T2 becomes too cold, i.e., where there is a possibility that the seawater at temperature T2 could freeze during regasification operations. On the other hand, as seawater transitions from an intake temperature T2 to a warmer intake temperature of T1, marine regassification system 10 may transition from primary use of SCV module(s) 16 to primary use of WHV module(s) 20, and may even suspend use of SCV module(s) 16 where there is sufficient free energy in the seawater at temperature T1 to support all gasification needs. This would minimize the need to produce additional heat for use in the SCV modules 16, and thus improve efficiency of marine regassification system 10 when possible.

In other embodiments, WHV modules 20 and SCV modules 16 may be operated simultaneously to meet demand for natural gas, such as where demand is higher than either one of the WHV module 20 and SCV module 16 could produce without operation of the other.

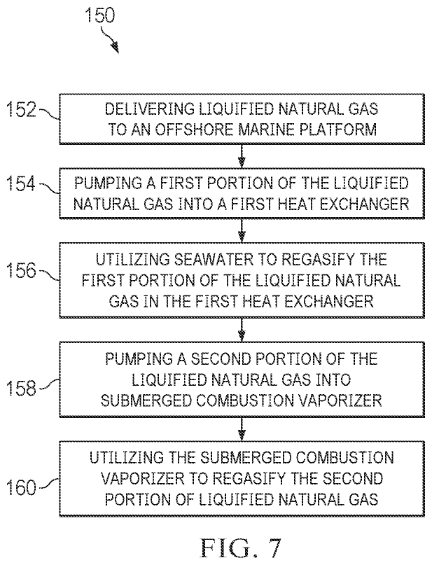

FIG. 7 illustrates one embodiment of a method for offshore regassification of liquified gas 150 as described above. In a first step 152, liquified gas is delivered to an offshore marine platform. The liquified gas may be liquified natural gas, or another liquified gas. The liquified gas may be delivered by a marine transport vessel or by pipeline. In one or more embodiments, the offshore marine platform is fixed to the ocean floor so as to minimize movement of the offshore marine platform from waves, wind, ocean currents and the like. In step 154, a first portion of the liquified natural gas is pumped to a first heat exchanger. The first heat exchanger may be an WHV module. The first heat exchanger may be mounted on the offshore marine platform or mounted on a floating vessel or other fixed structure adjacent the offshore marine platform. In step 156, seawater is utilized to regasify the first portion of the liquified natural gas in the first heat exchanger. The seawater may be drawn in from adjacent the offshore marine platform. The seawater may be used directly to transfer heat to liquified gas in the first heat exchanger, or may be utilized to transfer heat via an intermediate fluid as described above. In step 158, a second portion of the liquified natural gas is pumped into a submerged combustion vaporizer. In one or more embodiments, steps 158 and 156 may occur in parallel. In one or more embodiments, steps 158 and 156 may occur simultaneously. In step 160, the submerged combustion vaporizer is utilized to regasify the second portion of liquified natural gas. In one or more embodiments, the volume of liquified gas pumped to the first heat exchanger may be decreased while the volume of liquefied gas pumped to the submerged combustion vaporizer may increased. The change in pumped volumes may be based on a measurement of the seawater, such as the intake temperature or the return temperature, or a measurement of the natural gas produced by the first heat exchanger, such as the temperature of quality of the natural gas produced by the first heat exchanger. In one or more embodiments, the liquified gas is pumped to each of a first heat exchanger and a submerged combustion vaporizer in parallel.

The marine regasification system 10 as described herein is provided to ensure that where ocean water becomes too cold for regassification using WHV modules 20, SCV modules 16 may be utilized in parallel or in the alternative, depending on the temperature of the water and reh regasification needs. Where seawater outlet temperature from an WHV module 20 approaches 0° C., all or a portion of the LNG regassification effort may be transitioned to SCV modules 16 to avoid either i) an undesirable seawater return temperature or ii) freezing of the seawater in the WHV module 20. Finally, while embodiments of marine regasification system 10 have been described as including a marine platform 12, as illustrated in FIGS. 5 and 6, in some embodiments, marine regasification system 10 may be practiced onshore so long as seawater is utilized as described herein. In such case, one or more of the WHV modules 20, the SCV modules 16 and LNG storage tanks 26 may be shore-based so long as they are in parallel fluid communication as described herein.

Thus, a marine system for regassification of liquified gas has been described herein. In one or more embodiments, the marine system may include a fixed marine platform; one or more submerged combustion vaporizer (SCV) modules mounted on the fixed marine platform; one or more water heated vaporizer (WHV) modules adjacent the fixed marine platform; a pipe network fluidically connecting the one or more SCV modules and the one or more WHV modules in parallel with one another. In other embodiments, the marine system may include a fixed marine platform; a floating marine vessel moored adjacent the fixed marine platform, the floating marine platform having one or more LNG storage tanks carried thereon; one or more submerged combustion vaporizer (SCV) modules mounted on the fixed marine platform, the one or more SCV modules each having a tank filled with a heat transfer bath, a heat exchanger tube bank disposed within the tank, one or more combustion gas conduits disposed within the tank, a combustion chamber with a combustion gas outlet in fluid communication with the one or more combustion gas conduits, a fuel gas inlet in fluid communication with the combustion chamber and a combustion air inlet in fluid communication with the combustion chamber; one or more water heated vaporizer (WHV) modules mounted on the fixed marine platform, wherein the one or more WHV modules each comprises a working fluid inlet, a working fluid outlet, an LNG inlet, a natural gas outlet and at least one first heat exchanger; a sensor disposed to measure a condition of natural gas at the natural gas outlet of the WHV module; and at least one adjustable valve disposed to control LNG flow to the one or more WHV modules and the one or more SCV modules based on the sensor. In yet other embodiments, the marine system may include a fixed marine platform; a submerged combustion vaporizer module mounted on the fixed marine platform; and a water heated vaporizer module mounted on the fixed marine platform. It yet other embodiments, the marine system may include a fixed marine platform; a submerged combustion vaporizer module mounted on the fixed marine platform; and a water heated vaporizer module. It yet other embodiments, the marine system may include a fixed marine platform; a submerged combustion vaporizer module mounted on the fixed marine platform; a water heated vaporizer module mounted on the fixed marine platform; and a floating marine platform moored adjacent the fixed marine platform, the floating marine platform having one or more LNG storage tanks carried thereon. In yet other embodiments, the marine system may include a fixed marine platform; a floating marine vessel moored adjacent the fixed marine platform, the floating marine platform having one or more LNG storage tanks carried thereon; a submerged combustion vaporizer module mounted on the fixed marine platform, the SCV module having a tank filled with a heat transfer bath, a heat exchanger tube bank disposed within the tank, one or more combustion gas conduits disposed within the tank, a burner with a combustion gas outlet in fluid communication with the one or more combustion gas conduits, a fuel gas inlet in fluid communication with the burner and a combustion air inlet in fluid communication with the burner; a water heated vaporizer module mounted on the fixed marine platform, wherein the water heated vaporizer module comprises a first shell and tube heat exchanger and a second heat exchanger, the first shell and tube heat exchanger having a vessel with a working fluid inlet and a working fluid outlet, a working fluid disposed in the vessel, and a tube bundle disposed in vessel, the tube bundle having an LNG inlet and a NG outlet, and the second heat exchanger comprises a heat exchanger interface with a seawater inlet and a seawater outlet, a working fluid inlet and a working fluid outlet, wherein the working fluid inlet of the first shell and tube heat exchanger is in fluid communication with the working fluid outlet of the second heat exchanger, and the working fluid outlet of the first shell and tube heat exchanger is in fluid communication with the working fluid inlet of the second heat exchanger; a temperature sensor disposed to measure the temperature of natural gas at the natural gas outlet of the water heated vaporizer module; and at least one adjustable valve disposed to control LNG flow to one of the water heated vaporizer module or the SCV module based on the temperature sensor. It yet other embodiments, the marine system may include a source of liquified natural gas (LNG); a submerged combustion vaporizer (SCV) module fluidically coupled to the LNG; and an open rack vaporizer module fluidically coupled to the LNG source. In one or more other embodiments, the marine system may include one or more submerged combustion vaporizer (SCV) modules; one or more open water heated vaporizer (WHV) modules; and a pipe network fluidically connecting the one or more SCV modules and the one or more WHV modules in parallel with one another.

Any of the foregoing marine systems may further include, alone or in combination, any of the following:
A floating marine platform moored adjacent the fixed marine platform, the floating marine platform having one or more liquified gas storage tanks carried thereon.
One or more water heated vaporizer (WHV) modules mounted on the fixed marine platform.
At least one SCV module comprises a tank having a heat transfer bath disposed therein with a heat exchanger disposed within the tank; one or more combustion gas conduits disposed within the tank; and a combustion chamber with a combustion gas outlet in fluid communication with the one or more combustion gas conduits.
At least one WHV module comprises a first heat exchanger having an LNG inlet, a natural gas outlet, a working fluid inlet and a working fluid outlet, wherein the working fluid inlet is in fluid communication with a seawater intake pump.
At least one WHV module comprises a first heat exchanger having an LNG inlet, a natural gas outlet, a working fluid inlet and a working fluid outlet; and a second heat exchanger having a seawater inlet, a seawater outlet, a working fluid inlet and a working fluid outlet, wherein the seawater inlet is in fluid communication with a seawater intake pump, wherein the working fluid inlet of the first heat exchanger is in fluid communication with the working fluid outlet of the second heat exchanger, and wherein the working fluid outlet of the first heat exchanger is in fluid communication with the working fluid inlet of the second heat exchanger.
A process fluid flow loop with a working fluid disposed therein, wherein the process fluid flow loop fluidically couples the first heat exchanger and the second heat exchanger via the working fluid inlet and working fluid outlet of the first heat exchanger and the working fluid inlet and working fluid outlet of the second heat exchanger.
At least one first heat exchanger of the WHV module comprises a plurality of vertical heat exchange tube banks, each vertical heat exchange tube bank formed of a plurality of elongated tubes, the elongated tubes in fluid communication at a lower end of the tube banks with the LNG inlet and in fluid communication at the upper end of the tube banks with the natural gas outlet; a working fluid distribution system disposed adjacent the upper end of the tube banks and in fluid communication with the working fluid inlet.
The working fluid distribution system is a reservoir positioned adjacent upper end of the tube banks.
The one or more WHV modules each further comprise a second heat exchanger; and a process fluid flow loop fluidically connecting a first heat exchanger and a second heat exchanger.
An intermediate fluid disposed in the process fluid flow loop.
A second heat exchanger having a seawater inlet, a seawater outlet, a working fluid inlet and a working fluid outlet; and a process fluid flow loop with a working fluid disposed therein, wherein the process fluid flow loop fluidically couples the first heat exchanger and the second heat exchanger via the working fluid inlet and working fluid outlet of the first heat exchanger and the working fluid inlet and working fluid outlet of the second heat exchanger, wherein the seawater inlet of the second heat exchanger is in fluid communication with a seawater intake pump.
The working fluid a glycol and water mixture.
The seawater inlet of the second heat exchanger is in fluid communication with a seawater intake disposed along a first leg of the fixed marine platform and the seawater outlet of the second heat exchanger is in fluid communication with a seawater discharge disposed along a second leg of the fixed marine platform.
The SCV module and the ORV module are fluidically coupled to the LNG source in parallel.
A temperature sensor disposed to measure the temperature of natural gas at a natural gas outlet of the WHV module and at least one adjustable valve disposed to control LNG flow to each of the WHV module and the SCV module based on the temperature sensor.
A pipe manifold system fluidically coupled to the one or more LNG storage tanks and each of the SCV module and the WHV module.
The SCV module and the WHV module are fluidically coupled to the pipe manifold system in parallel.
The WHV module is mounted on the fixed marine platform.
The WHV module is mounted on the floating marine platform.
The floating marine platform is a ship.
The WHV module comprises one or more shell and tube heat exchangers or open rack vaporizers or similar
The WHV module comprises a first shell and tube heat exchanger and a second shell and tube heat exchanger.
The first shell and tube heat exchanger comprises a vessel with a working fluid inlet and a working fluid outlet, a working fluid disposed in the vessel, and a tube bundle disposed in vessel, the tube bundle having an LNG inlet and a NG outlet.
The second shell and tube heat exchanger comprises a vessel with a seawater inlet and a seawater outlet, a tube bundle disposed in vessel, the tube bundle having a working fluid inlet and a working fluid outlet.
The working fluid inlet of the first shell and tube heat exchanger is in fluid communication with the working fluid outlet of the second shell and tube heat exchanger, and the working fluid outlet of the first shell and tube heat exchanger is in fluid communication with the working fluid inlet of the second shell and tube heat exchanger.
The working fluid is an intermediate fluid.
The seawater inlet of the second shell and tube heat exchanger is in fluid communication with a seawater intake disposed along a first leg of the fixed marine platform and the seawater outlet of the second shell and tube heat exchanger is in fluid communication with a seawater discharge disposed along a second leg of the fixed marine platform.
The SCV module comprises a tank filled with a heat transfer bath, a heat exchanger tube bank disposed within the tank, one or more combustion gas conduits disposed within the tank, a burner with a combustion gas outlet in fluid communication with the one or more combustion gas conduits, a fuel gas inlet in fluid communication with the burner and a combustion air inlet in fluid communication with the burner.
The fixed marine platform comprises a deck and at least one [support] engaging the seabed.
The fixed marine platform comprises a deck supported on at least four legs, each leg including a base disposed to engage the seabed.
A sensor disposed to measure a condition of the natural gas at the natural gas outlet of the WHV module; and at least one adjustable valve disposed to control LNG flow to the SCV module based on the sensor.
At least one adjustable valve disposed to control LNG flow to the WHV module based on the temperature sensor.
A sensor disposed to measure a condition of the natural gas at the natural gas outlet of the WHV module; at least one adjustable valve disposed to control LNG flow to the SCV module based on the sensor; and at least one adjustable valve disposed to control LNG flow to the WHV module based on the sensor.
The intermediate fluid is a glycol and water mixture.
The intermediate fluid is propane.
The WHV module comprises one or more plate and frame heat exchangers.
The SCV module comprises one or more shell and tube heat exchangers.
The SCV module comprises one or more plate and frame heat exchangers.
The floating marine platform is a barge.
A temperature sensor disposed to measure the temperature of natural gas at a natural gas outlet of the WHV module; at least one adjustable valve disposed to control LNG flow to the SCV module based on the temperature sensor; and at least one adjustable valve disposed to control LNG flow to the WHV module based on the temperature sensor.
A sensor disposed to measure a condition of natural gas at a natural gas outlet of the WHV module; at least one adjustable valve disposed to control LNG flow to the SCV module; at least one adjustable valve disposed to control LNG flow to the WHV module; and a controller disposed to monitor the sensor and adjust each of the adjustable valves of the SCV module and the WHV module based on the measured condition by the sensor.
The heat exchanger interface comprises a plurality of heat transfer plates stacked together to form a heat plate bank.
The heat exchanger interface comprises a tube bundle disposed within a vessel.

Likewise, a method for the regassification of liquified gas has been described. The regassification method may include delivering liquified natural gas to a marine platform; pumping a first portion of the liquified natural gas into a first heat exchanger; utilizing seawater to regasify the first portion of the liquified natural gas in the first heat exchanger; pumping a second portion of the liquified natural gas into submerged combustion vaporizer; utilizing the submerged combustion vaporizer to regasify the second portion of liquified natural gas. In other embodiments, the regassification method may include pumping liquified natural gas from a storage vessel; introducing the pumped liquified natural gas into a first heat exchanger; utilizing seawater to regasify the liquified natural gas in the first heat exchanger; measuring a condition of the regasified natural gas; based on the measured condition of the regasified natural gas, directing a portion of the pumped liquefied natural gas to a submerged combustion vaporizer; and utilizing the submerged combustion vaporizer to regasify the liquified natural gas pumped to the submerged combustion vaporizer. In other embodiments, the regassification method may include delivering liquified natural gas to an a marine storage vessel; pumping liquified natural gas from the marine storage vessel; introducing the pumped liquified natural gas into a first heat exchanger; utilizing seawater to regasify the liquified natural gas in the first heat exchanger; measuring a condition of the regasified natural gas; based on the measured condition of the regasified natural gas, directing a portion of the pumped liquefied natural gas to a submerged combustion vaporizer; and utilizing the submerged combustion vaporizer to regasify the liquified natural gas pumped to the submerged combustion vaporizer. In other embodiments, the regassification method may include delivering liquified natural gas to an offshore marine storage vessel; pumping liquified natural gas from the offshore storage vessel; introducing a first portion of the pumped liquified natural gas into a first heat exchanger; utilizing seawater to regasify the liquified natural gas in the first heat exchanger; introducing a second portion of the pumped liquified natural gas into a submerged combustion vaporizer; and utilizing the submerged combustion vaporizer to regasify the liquified natural gas pumped to the submerged combustion vaporizer, wherein the regasification by the submerged combustion vaporizer and the first heat exchanger occurs simultaneously in parallel. In other embodiments, the regassification method may include pumping liquified natural gas from a storage vessel; introducing a first portion of the pumped liquified natural gas into a first heat exchanger; utilizing seawater to regasify the liquified natural gas in the first heat exchanger; introducing a second portion of the pumped liquified natural gas into a submerged combustion vaporizer; and utilizing the submerged combustion vaporizer to regasify the liquified natural gas pumped to the submerged combustion vaporizer, wherein the regasification by the submerged combustion vaporizer and the first heat exchanger occurs simultaneously in parallel.

Any of the foregoing embodiments of a method for regasifying liquefied gases may include alone or in combination, any of the following:
Wherein liquified natural gas is pumped to each of a first heat exchanger and a submerged combustion vaporizer in parallel.
Measuring a condition of the regasified natural gas from the first heat exchanger; based on the measured condition of the regasified natural gas, increasing the portion of liquefied natural gas pumped to the submerged combustion vaporizer; and decreasing the portion of the liquified natural gas pumped to the first heat exchanger.
Measuring a condition of the seawater utilized to regassify the first portion of liquified natural gas; based on the measured condition of the seawater, adjusting the portion of liquefied natural gas pumped to the submerged combustion vaporizer; and adjusting the portion of the liquified natural gas pumped to the first heat exchanger.
Measuring the temperature of seawater adjacent the marine platform, and as the measured temperature of the seawater increases, increasing the volume of liquified natural gas pumped to the first heat exchanger and decreasing the volume of liquified natural gas pumped to the submerged combustion vaporizer.
Delivering liquified natural gas to an offshore marine storage vessel moored adjacent the marine platform; pumping liquified natural gas from the offshore marine storage vessel to the submerged combustion vaporizer the marine platform; and simultaneously, pumping liquified natural gas from the offshore marine storage vessel to the first heat exchanger.
Wherein pumping a first portion of the liquified natural gas into a first heat exchanger comprises introducing the liquefied natural gas into a water heated vaporizer.

Although various embodiments have been shown and described, the disclosure is not limited to such embodiments and will be understood to include all modifications and variations as would be apparent to one skilled in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

1. A marine system for regassification of liquified gas comprising:
a fixed marine platform;
one or more submerged combustion vaporizer (SCV) modules mounted on the fixed marine platform;
one or more water heated vaporizer (WHV) modules adjacent the fixed marine platform; and
at least one adjustable valve disposed to selectively control liquified gas flow to the one or more WHV modules and the one or more SCV modules.

2. The marine system for regassification of claim 1, further comprising a floating marine unit moored adjacent the fixed marine platform, the floating marine unit having one or more liquified gas storage tanks carried thereon.

3. The marine system for regassification of claim 1, wherein the one or more water heated vaporizer (WHV) modules are mounted on the fixed marine platform.

4. The marine system for regassification of claim 1, wherein the one or more water heated vaporizer (WHV) modules are mounted on the floating marine platform.

5. The marine system for regassification of claim 1, wherein at least one SCV module comprises a tank having a heat transfer bath disposed therein with a heat exchanger disposed within the tank; one or more combustion gas conduits disposed within the tank; and a combustion chamber with a combustion gas outlet in fluid communication with the one or more combustion gas conduits.

6. The marine system for regassification of claim 1, wherein at least one WHV module comprises a first heat exchanger having an LNG inlet, a natural gas outlet, a working fluid inlet and a working fluid outlet, wherein the working fluid inlet is in fluid communication with a seawater intake pump.

7. The marine system for regassification of claim 1, wherein at least one WHV module comprises a first heat exchanger having an LNG inlet, a natural gas outlet, a working fluid inlet and a working fluid outlet; and a second heat exchanger having a seawater inlet, a seawater outlet, a working fluid inlet and a working fluid outlet, wherein the seawater inlet is in fluid communication with a seawater intake pump, wherein the working fluid inlet of the first heat exchanger is in fluid communication with the working fluid outlet of the second heat exchanger, and wherein the working fluid outlet of the first heat exchanger is in fluid communication with the working fluid inlet of the second heat exchanger.

8. The marine system for regassification of claim 7, further comprising a process fluid flow loop with a working fluid disposed therein, wherein the process fluid flow loop fluidically couples the first heat exchanger and the second heat exchanger via the working fluid inlet and working fluid outlet of the first heat exchanger and the working fluid inlet and working fluid outlet of the second heat exchanger.

9. A marine system for regassification of liquified natural gas comprising:
a fixed marine platform;
a floating marine vessel moored adjacent the fixed marine platform, the floating marine platform having one or more LNG storage tanks carried thereon;
one or more submerged combustion vaporizer (SCV) modules mounted on the fixed marine platform, the one or more SCV modules each having a tank filled with a heat transfer bath, a heat exchanger tube bank disposed within the tank, one or more combustion gas conduits disposed within the tank, a combustion chamber with a combustion gas outlet in fluid communication with the one or more combustion gas conduits, a fuel gas inlet in fluid communication with the combustion chamber and a combustion air inlet in fluid communication with the combustion chamber;
one or more water heated vaporizer (WHV) modules mounted on the fixed marine platform, wherein the one or more WHV modules each comprises a working fluid inlet, a working fluid outlet, an LNG inlet, a natural gas outlet and at least one first heat exchanger;
a sensor disposed to measure a condition of natural gas at the natural gas outlet of the WHV module; and
at least one adjustable valve disposed to control LNG flow to the one or more WHV modules and the one or more SCV modules based on the sensor.

10. The marine system for regassification of claim 9, wherein the at least one first heat exchanger of the WHV module comprises a plurality of vertical heat exchange tube banks, each vertical heat exchange tube bank formed of a plurality of elongated tubes, the elongated tubes in fluid communication at a lower end of the tube banks with the LNG inlet and in fluid communication at the upper end of the tube banks with the natural gas outlet; a working fluid distribution system disposed adjacent the upper end of the tube banks and in fluid communication with the working fluid inlet.

11. The marine system for regassification of claim 10, wherein the working fluid distribution system is a reservoir positioned adjacent upper end of the tube banks.

12. The marine system for regassification of claim 9, wherein the one or more WHV modules each further comprise a second heat exchanger; and a process fluid flow loop fluidically connecting a first heat exchanger and a second heat exchanger.

13. The marine system for regassification of claim 12, further comprising an intermediate fluid disposed in the process fluid flow loop.

14. The marine system for regassification of claim 10, further comprising a second heat exchanger having a seawater inlet, a seawater outlet, a working fluid inlet and a working fluid outlet; and a process fluid flow loop with a working fluid disposed therein, wherein the process fluid flow loop fluidically couples the first heat exchanger and the second heat exchanger via the working fluid inlet and working fluid outlet of the first heat exchanger and the working fluid inlet and working fluid outlet of the second heat exchanger, wherein the seawater inlet of the second heat exchanger is in fluid communication with a seawater intake pump.

15. A method of for regassification of liquified natural gas comprising:
delivering liquified natural gas to a marine platform;
pumping a first portion of the liquified natural gas into a first heat exchanger;
utilizing seawater to regasify the first portion of the liquified natural gas in the first heat exchanger;
pumping a second portion of the liquified natural gas into submerged combustion vaporizer; and
utilizing the submerged combustion vaporizer to regasify the second portion of liquified natural gas.

16. The method of claim 15, wherein liquified natural gas is pumped to each of a first heat exchanger and a submerged combustion vaporizer in parallel.

17. The method of claim 15, further comprising measuring a condition of the regasified natural gas from the first heat exchanger; based on the measured condition of the regasified natural gas, increasing the portion of liquefied natural gas pumped to the submerged combustion vaporizer; and decreasing the portion of the liquified natural gas pumped to the first heat exchanger.

18. The method of claim 15, further comprising measuring a condition of the seawater utilized to regassify the first portion of liquified natural gas; based on the measured condition of the seawater, adjusting the portion of liquefied natural gas pumped to the submerged combustion vaporizer; and adjusting the portion of the liquified natural gas pumped to the first heat exchanger.

19. The method of claim 15, further comprising measuring the temperature of seawater adjacent the marine platform, and as the measured temperature of the seawater increases, increasing the volume of liquified natural gas pumped to the first heat exchanger and decreasing the volume of liquified natural gas pumped to the submerged combustion vaporizer.

20. The method of claim 15, further comprising delivering liquified natural gas to an offshore marine storage vessel moored adjacent the marine platform; pumping liquified natural gas from the offshore marine storage vessel to the submerged combustion vaporizer the marine platform; and simultaneously, pumping liquified natural gas from the offshore marine storage vessel to the first heat exchanger.

21. The method of claim 15, wherein pumping a first portion of the liquified natural gas into a first heat exchanger comprises introducing the liquefied natural gas into a water heated vaporizer.
